(19) United States
(12) Patent Application Publication
(10) Pub. No.: US 2026/0350542 A1
(43) Pub. Date: Nov. 5, 2026

(54) PIPA: AI-Powered Agile Backlog Generator with CURT Scoring-Based Sizing and Prioritization

(71) Applicant: Damilola Adeyemo, Frisco, TX (US)

(72) Inventor: Damilola Adeyemo, Frisco, TX (US)

(21) Appl. No.: 19/197,258

(22) Filed: May 2, 2025

(51) Int. Cl. G06Q 10/10; G06F 8/20

(52) U.S. Cl. CPC G06Q 10/103; G06F 8/20

(57) ABSTRACT

Disclosed herein is an AI-powered software system that automates the transformation of raw stakeholder requirements into structured Agile backlog items—including Epics, Features, and User Stories—complete with acceptance criteria, CURT-based sizing (Complexity, Uncertainty, Risk, Time), and value estimation. PIPA employs natural language processing and domain-specific prompt logic to derive business goals, generate Agile artifacts, assign rationale-backed sizing, and prioritize backlog items for delivery. Each artifact is exportable in formats compatible with Jira, Azure DevOps, and similar platforms. PIPA significantly reduces the manual overhead in backlog refinement and ensures consistency, clarity, and speed in Agile planning processes. Its secure, multi-tenant architecture enables safe, concurrent usage across multiple organizations. Unlike existing tools that focus on isolated functions like summarization or ticket generation, PIPA delivers full end-to-end decomposition, rational estimation, and seamless export, marking a transformative advancement in Agile planning and delivery workflows.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to software development lifecycle tools and more specifically to artificial intelligence systems that automate the transformation of raw stakeholder requirements into structured Agile backlog items. It encompasses Agile project planning, requirement decomposition, backlog sizing, and prioritization. The invention also includes integration with project management platforms and data security for multi-tenant environments.

### Description of the Related Art

Agile methodologies have become the dominant approach in software development and project management due to their iterative nature, adaptability, and focus on customer collaboration. Central to Agile frameworks such as Scrum, SAFe, and Kanban is the concept of the product backlog—a prioritized list of Epics, Features, and User Stories that define the scope and direction of a project. Traditionally, these backlog items are created manually by Product Owners or Agile teams based on stakeholder inputs, which are often unstructured and ambiguous. The process of converting these high-level inputs into actionable backlog items involves significant time, discussion, and subjective interpretation. As Agile adoption grows across industries, the demand for efficient, accurate, and scalable backlog management solutions has intensified.

Efficient backlog creation is critical to maintaining development velocity, reducing planning overhead, and delivering customer value on time. Studies indicate that up to 25-30% of a Scrum team's time can be consumed by backlog refinement and planning activities. This burden often leads to inconsistent sizing, prioritization issues, and delayed releases. Additionally, poor decomposition of requirements can result in incomplete stories, unclear acceptance criteria, and delivery misalignment. Automating the conversion of stakeholder needs into properly structured Agile artifacts has the potential to transform Agile planning, making it faster, more consistent, and less resource-intensive. By addressing these inefficiencies, organizations can improve time-to-market, reduce costs, and enhance cross-functional collaboration.

According to the 17th Annual State of Agile Report, over 70% of organizations practice Agile at some level, yet only 32% rate their backlog management processes as “mature.” Another industry survey by VersionOne revealed that backlog grooming was among the top five most challenging Agile practices. Furthermore, Gartner estimates that 60% of digital product failures can be traced back to poorly defined or misaligned requirements. These statistics highlight a clear gap between Agile theory and practice, particularly in early-stage planning and backlog refinement. Automating this segment of the lifecycle using AI offers not only efficiency gains but also measurable improvements in delivery quality and stakeholder satisfaction.

Several tools and platforms have attempted to bring AI and automation into the Agile planning process. Atlassian's Rovo and Jira AI features focus on summarizing discussions and recommending tickets based on user inputs. StoriesOnBoard has integrated basic AI functions to generate initial story ideas from user inputs. Spinach AI helps teams automate meeting notes and highlights to assist with planning conversations. These tools mark the beginning of AI application in Agile environments, particularly in supporting team communication and generating initial backlog content. However, their core functionality remains limited to summarization, transcription, or simple item creation without full decomposition logic or multi-tiered integration.

By looking at prior art, multiple innovations can be seen in similar field. For instance, Artificial Intelligence and Machine Learning Based Product Release Planning Assistant bearing US patent number 2,019,0050771A1 discloses an invention describes a release planning assistant that utilizes artificial intelligence to generate release plans, including sprint timelines and sprint backlogs. It incorporates automated release plan generation, management of story dependencies, prediction of schedule overruns, and estimation of deployment dates based on selected backlogs and team velocity.

An EP patent 3,388,986A1 relates to an End-to-End Project Management Platform with Artificial Intelligence. This patent outlines a project management platform that integrates various tools into a cohesive system. It includes an automation layer to automate tasks associated with the project, such as development operations, maintenance, management, and testing. The platform leverages AI to enhance efficiency in project management processes.

A US patent 1,226,5922B2 relates to System and Method for Automated Software Development Through AI. This invention presents a system that employs AI to gather requirements from business analysts and generate runnable software applications. It focuses on automating the software development process by interpreting requirements and translating them into functional software components.

A US patent 2,022,0391803A1 relates to Method and System for Using Artificial Intelligence for Task Management. This patent application discusses a method where AI is used to manage tasks by receiving task descriptions, generating execution plans based on historical task management information, initiating task execution, and tracking progress to ensure alignment with the generated plan.

A US patent 20230385825A1 relates to an Agile Iteration for Data Mining Using Artificial Intelligence. This invention relates to techniques for training an entity resolution model by receiving scopes from users, determining data mining goals, defining proof of concept models, and selecting models for training, all within an Agile framework enhanced by AI.

Despite these innovations, Agile practitioners still face major challenges. Most tools do not support hierarchical decomposition from Epic to Story, nor do they offer explainable sizing or value-based prioritization. There is minimal integration of objective sizing frameworks like CURT (Complexity, Uncertainty, Risk, Time), and almost none provide the ability to trace sizing decisions back to rationale. Additionally, backlog outputs often require further manual editing and restructuring to align with existing project tools, resulting in duplicated effort and risk of error. Data privacy and tenant-specific configuration are also poorly handled in most AI-backed tools, limiting their adoption in enterprise settings. Overall, these solutions are fragmented and fail to deliver an end-to-end refinement workflow.

The Project Intelligence and Planning Assistant (PIPA) is a comprehensive AI-driven system designed to fully automate the conversion of raw stakeholder requirements into structured Agile backlog items, complete with sizing, prioritization, and acceptance criteria. Unlike existing tools, PIPA performs deep decomposition across multiple levels—identifying business goals, generating Epics and Features, and breaking them into detailed User Stories. It applies the CURT framework to size each item objectively, with explanations for every score, and assigns estimated business value to aid in prioritization. PIPA's modular design allows seamless export into popular Agile tools like Jira, Azure DevOps, and Trello, enabling rapid handoff to development teams with minimal friction.

PIPA bridges the gap between high-level stakeholder vision and detailed technical execution by automating one of the most labor-intensive parts of Agile workflows. It offers not just ticket generation, but intelligent backlog planning—complete with rationale, prioritization logic, and export-ready structure. By integrating AI decomposition, CURT-based scoring, and secure multi-tenant deployment, PIPA delivers unmatched depth, transparency, and scalability. It empowers organizations to reduce planning time by over 50%, improve backlog accuracy, and create a consistent estimation culture. Most importantly, it addresses the limitations of current tools by offering a true end-to-end solution that transforms how Agile teams plan and prioritize work in an increasingly complex and fast-paced environment.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

The present invention seeks to improve prior techniques and provide an AI-powered agile backlog generator with CURT-based sizing and prioritization.

It is the objective of the invention to automate the transformation of high-level stakeholder requirements into structured Agile backlog items to eliminate manual decomposition efforts.

A further objective of the present invention is to improve the consistency and quality of Agile planning artifacts through AI-driven interpretation, decomposition, and criteria generation.

It is also an object of the invention to implement a standardized CURT scoring system to objectively size backlog items across multiple dimensions: Complexity, Uncertainty, Risk, and Time.

It is further the objective of the invention to reduce the planning cycle time by eliminating the need for repeated backlog refinement meetings.

It is also the objective of the invention to ensure explainability and transparency in all AI-generated outputs by providing human-readable rationale for CURT scores and sizing decisions.

The objective of the invention is to facilitate prioritization by attaching value estimation metadata to each backlog item.

It is also the objective of the invention to enable seamless export and integration of backlog artifacts with existing project management tools such as Jira, Azure DevOps, and Trello.

It is further the objective of the invention to maintain strict data security and isolation across multiple organizations through a multi-tenant architecture.

The invention aims to allow customization of decomposition, scoring, and export workflows based on organizational standards and planning practices.

It is the objective of the invention to support continuous backlog improvement through feedback loops, iterative refinement, and historical performance analysis.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention relates to the field of software project management and Agile methodology, specifically targeting the automation of backlog generation, refinement, and prioritization through the use of artificial intelligence. PIPA addresses a critical bottleneck in modern Agile teams: the time-consuming and inconsistent process of translating stakeholder requirements into properly structured Agile backlog items such as Epics, Features, and User Stories. The invention replaces manual refinement processes with a sophisticated, AI-powered engine capable of interpreting raw requirements and producing ready-to-use Agile artifacts with embedded sizing and value metrics.

As per preferred embodiments of the invention, the PIPA begins its operation with an Input Interface designed to receive unstructured or structured stakeholder inputs. These inputs may include meeting notes, voice transcriptions, feature briefs, or user requests. Once received, these inputs are processed by a custom AI decomposition engine built on a Large Language Model (LLM), specifically trained and fine-tuned for Agile terminology, planning logic, and business goal mapping. The decomposition engine identifies overarching business themes and aligns them with corresponding Epics, which are defined with descriptive titles, contextual narratives, and business value estimations.

As per further embodiments of the invention, each Epic generated is automatically decomposed into subordinate Features, which represent key capabilities or milestones needed to fulfill the broader Epic. Features are sized using T-shirt estimations (XS to XL), a familiar method for many Agile teams. The engine provides explanations for these sizes based on contextual cues and complexity levels identified in the input. These Features are then further broken down into User Stories, written in a standardized format with clear titles, descriptions, and comprehensive acceptance criteria. User Stories are estimated using a Fibonacci sequence for effort sizing (e.g., 1, 2, 3, 5, 8, etc.), ensuring consistency with widely adopted Agile practices.

As per further embodiments of the invention, an essential component of the system is the CURT Scoring Module, which evaluates each backlog item against four dimensions: Complexity, Uncertainty, Risk, and Time. Each dimension receives a numerical score on a 1-to-5 scale. This scoring is not only machine-generated but also includes a rationale—written in human-readable form—so that Agile teams can understand and trust the basis for each decision. This transparency addresses a key challenge in AI-driven planning: interpretability and user confidence.

As per further embodiments of the invention, in addition to CURT scoring, the invention includes a Value Estimation Layer. This layer attaches a business value rating to each backlog item, enabling product managers and Scrum teams to make informed prioritization decisions. The value rating is computed based on stakeholder intent, market impact, and alignment with organizational goals, which are inferred through natural language analysis and historical data trends where available.

As per further embodiments of the invention, the final structured output is routed through an Export and Integration Module. This module prepares Agile artifacts in multiple formats, including JSON and CSV, ensuring compatibility with mainstream project management tools such as Jira, Azure DevOps, Trello, Asana, and Monday.com. The export process can be triggered manually or configured for automated synchronization via API, allowing teams to seamlessly integrate the generated backlog into their existing workflows without additional reformatting or manual entry.

As per further embodiments of the invention, the entire system is built on a secure, multi-tenant architecture that supports simultaneous use by multiple organizations while ensuring complete data segregation. Each tenant's data, configurations, and planning history are logically isolated and encrypted. Access is managed via role-based permissions and industry-standard authentication protocols such as OAuth2 and SAML. This ensures that sensitive project information remains confidential and compliant with organizational and regulatory requirements.

As per further embodiments of the invention, customization is another key feature of the invention. Tenants can tailor various aspects of the system, including decomposition depth, CURT scoring thresholds, estimation models, and export templates. This adaptability allows organizations of varying Agile maturity levels to use PIPA in a way that aligns with their specific methodologies, whether Scrum, SAFe, or hybrid approaches. Over time, the system learns from tenant-specific feedback and interactions, improving its accuracy and alignment with organizational planning preferences.

As per further embodiments of the invention, PIPA not only accelerates the Agile planning cycle but also enhances the quality and reliability of backlog items. By eliminating subjective estimations and manual breakdowns, it minimizes discrepancies, reduces planning overhead, and fosters better alignment among product stakeholders, development teams, and business executives. The invention transforms Agile refinement from a time-draining task into a high-speed, data-driven operation backed by AI intelligence and explainable decision-making.

As per further embodiments of the invention, in essence, the invention offers a comprehensive, end-to-end solution for intelligent Agile backlog generation. It integrates natural language processing, machine learning, and project management practices into a single platform that significantly improves the efficiency, consistency, and strategic value of software development planning. Through its modular, explainable, and extensible design, PIPA stands apart from existing tools by delivering not just ticket generation, but full Agile decomposition, scoring, prioritization, and export—making it a breakthrough innovation in the Agile tooling landscape.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. An AI-based system for automated transformation of stakeholder requirements into a structured Agile backlog, the system comprising:
an input module configured to receive stakeholder requirements in free-text or structured format;
a decomposition engine configured to generate Epics, Features, and User Stories from the input;
a criteria module for assigning acceptance criteria;
a scoring module applying CURT (Complexity, Uncertainty, Risk, Time) ratings to each backlog item; and
an export module configured to format backlog items for integration with project management tools.
As per claim 1, the decomposition engine uses a pre-trained Large Language Model (LLM) augmented with domain-specific prompt logic.
As per claim 1, the generated Agile hierarchy includes Epics annotated with business value estimates.
As per claim 1, the features are automatically assigned size estimates using a T-shirt sizing model.
As per claim 1, the user stories are sized using a Fibonacci scale and include detailed, AI-generated acceptance criteria.
As per claim 1, the system provides interactive previews of the generated backlog items before export.
As per claim 1, the export module supports Jira, Azure DevOps, Trello, and CSV/JSON formats.
As per claim 1, the system includes feedback loops to iteratively refine backlog accuracy over time.

2. A scoring module integrated within the system, configured to assign a CURT score to each Agile backlog item, wherein the module outputs both a numeric rating and a human-readable explanation for each CURT dimension.
As per claim 2, each CURT dimension is independently calculated on a 1-5 scale using NLP-derived semantic complexity analysis.
As per claim 2, the explanations for CURT scores are generated based on domain heuristics and historical pattern matching.
As per claim 2, the CURT scores influence both prioritization logic and sizing estimates.
As per claim 2, the scoring module can be configured per organization to adapt to specific risk tolerances.
As per claim 2, the visual dashboard summarizes CURT trends across multiple backlog items.
As per claim 2, users can toggle between AI-assigned and manual scoring modes.
As per claim 2, the CURT data is exportable for use in reporting and compliance documentation.

3. A secure, multi-tenant software architecture for Agile backlog generation, wherein each tenant's data, configurations, and history are logically and physically isolated, and accessible only by authorized users within the tenant organization.
As per claim 3, tenants are authenticated via industry-standard protocols including OAuth2 and SAML.
As per claim 3, the system implements role-based access controls for backlog access and editing.
As per claim 3, tenant configurations include branding, sizing models, export preferences, and scoring thresholds.
As per claim 3, each tenant's Agile planning session is stored in a separate encrypted container.
As per claim 3, audit logs are maintained per tenant for tracking data changes and access events.
As per claim 3, the architecture supports region-specific data hosting to meet compliance requirements.
As per claim 3, the system provides tenant-specific APIs for integration into enterprise systems.
